(19) United States
(12) Patent Application Publication
(10) Pub. No.: US 2006/0221056 A1
(43) Pub. Date: Oct. 5, 2006

(54) Method and system for inputting single-stroke code

(75) Inventors: Chang-Chin Lai, Taipei (TW); Vam Chang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/097,407

(22) Filed: Mar. 31, 2005

(51) Int. Cl. G09G 5/00

(52) U.S. Cl. 345/168

(57) ABSTRACT

A single-stroke code input method and system applicable to on electronic equipment with an inputting device and a monitor enables users to use the inputting device as a writing media and perform the writing directly on the monitor. The system connecting to the inputting device and the monitor includes at least a control key detection module, a cursor position detection module, an operational region specifying module, a cursor route identification module, and a code database. When activation of a control key on the inputting device is detected, the system sets the current position of a cursor corresponding to the input device as the initial position and specifies an operating region within which continuous route of the moving cursor is traced, so that a code is identified and the corresponding notation can be found accordingly.

### FIELD OF THE INVENTION

The present invention relates to a data input technique, and more particularly, to a single-stroke code input method and system that allows required data to be inputted via a input device.

### DESCRIPTION OF THE PRIOR ART

In the past, computers only have English character internal codes instead of Chinese character internal codes, so users can only input English data into the computers but not Chinese. Hence, the use of computers is not common among Chinese regions. In these days, due to the invention of Chinese character internal codes, keyboards with Chinese characters thereon can be commercialized, so that computers become more and more popular in Chinese regions.

Even so, inputting Chinese is not as easy as inputting English, for which just inputting a few alphabets will form a word. Chinese words are complex in terms of their structures, and also there are characters with same form but different pronunciations or different characters with similar forms involved. For most people, it is confusing enough to write them down manually, not to mention to type them up. Hence in order to improve the convenience of Chinese typing, many people have invented various Chinese input methods, such as Tsang-Jye, columns and rows, Wu-Xia-Mi and phonetic notations to improve the inputting speed for the Chinese users.

However, in terms of popularity of the above input methods, phonetic input method is the most common one because it uses a well-known Chinese characters assembly form. Unlike other input methods, users need to learn other ways of disassembling and assembling the characters. However, apart from wide acceptance of the phonetic input method, it involves too many keystrokes, which slows down the inputting speed. In practical cases, although users are already familiar with phonetic notations of the characters, it still takes time to locate positions of the keys on the keyboard so that the inputting speed of phonetic input method cannot be vastly improved like other input methods.

Moreover, if the background lighting is insufficient in the users' working environment, the inputting speed will be slowed down even more as it takes more time to locate the key positions.

Hence, in order to improve the disadvantage of slowing down the inputting speed due to finding key positions, others have proposed a writing pad, which is similar to writing on a paper with a pen, and where characters are inputted on the writing pad. Accordingly, inputting speed can be improved but since the writing pad is an external device, it is not very portable when used with laptop computers.

Therefore, how to reduce the time spent on finding key positions and subsequently improve data inputting speed and efficiency is an urgent technical problem to be solved.

### SUMMARY OF THE INVENTION

In order to solve the problems of the prior art, a primary objective of the present invention is to provide a single-stroke code input method and system, which inputs required data directly on the monitor based on a continuous route of a moving cursor on the inputting device and prevents the disadvantage of spending a lot of time to locate key positions.

Another objective of the present invention is to provide a single-stroke code input method and system, which inputs required data directly on the monitor using the inputting device of the electronic equipment without relying on any other external devices to save cost.

In order to achieve the above objectives, the present invention aims to provide a single-stroke code input method and system.

The single-stroke code input method includes: (1) the single-stroke code input system detecting activation of a control key on the inputting device, if detected, proceeds to step (2); otherwise retaining original functionality of the inputting device; (2) the input system detecting a cursor position on the monitor corresponding to the inputting device in order to specify an initial position; (3) the system specifying an operating region starting from the initial position; and (4) the system determining a notation corresponding to the code formed by tracing the continuous route of the moving cursor in the operating region.

The single-stroke code input system includes: (1) a control key detection module, which sends out a start signal when activation of a control key on the inputting device is detected; (2) a cursor position detection module, which starts to detect a cursor position on the monitor corresponding to the inputting device after receiving the start signal; (3) an operating region specifying module, which specifies a region on the monitor for user's input based on the detected cursor position; (4) a cursor route identification module, which traces a continuous route of the moving cursor within the operating region to identify a code represented by the route; and (5) a code database, which finds a notation corresponding to the identified code represented by the continuous route, and displays the notation on the monitor.

To summarize the above, when activation of the control key on the inputting device is detected, the single-stroke code method and system of the present invention sets the current position of the cursor as the initial position and specifies an operating region within which routines of continuous movement of the cursor are traced, so that a specifying code is identified and the corresponding symbol can be found accordingly. Hence the users are able to input information directly on the monitor to save time spent on finding key positions and subsequently improve efficiency of data input.

### BRIEF DESCRIPTION OF THE DRAWINGS

A better understanding of the present invention can be obtained when the forgoing detailed description is considered in conjunction with the following drawings, in which:

FIG. 1 is a flowchart showing the steps implemented by the single-stroke code input method of the present invention;

FIG. 2 is a block diagram showing the system structure of the single-stroke code input method of the present invention; and

FIG. 3 (A) and FIG. 3 (B) are illustrations showing input operations of the single-stroke code method and system of the present invention in a laptop computer.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

In the following embodiment, the present invention is applied in a laptop computer, for which the inputting device is a mouse. In this case, a perspective of the present invention is further clarified but the scope of the present invention should not be limited by any specific viewpoints (for example, the inputting device can be a touchpad and the laptop computer can be a desktop computer).

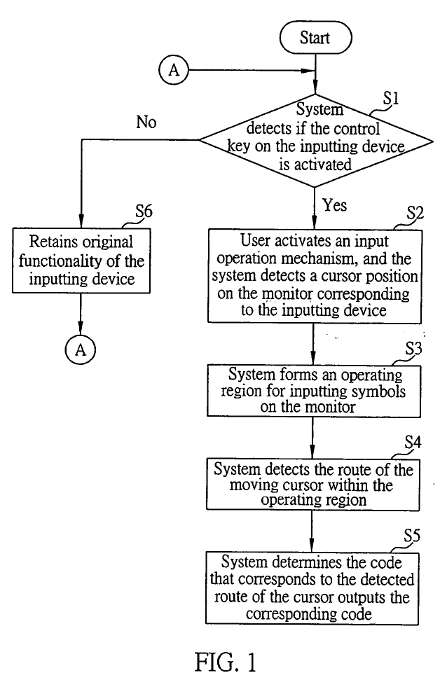

FIG. 1 is a flowchart showing implementation steps of the single-stroke code input method of the present invention. The present invention is applicable to a laptop computer with a mouse as the inputting device so that the users can use the mouse to enter Chinese phonetic notations and Arabic numerals to avoid spending time on finding key positions. As illustrated, firstly, in step S1, a single-stroke code input system of the present invention detects if a middle button (or left or right button according to different application) of the mouse (not shown) has been pressed down, if yes, it means the user has activated the control key of the inputting mechanism, so proceeds to step S2, otherwise retains the original functionality of the mouse and does not proceed to step S2 till the middle button is pressed down by the user.

In step S2, the input system activates the inputting mechanism and detecting the current cursor position on the monitor corresponding to the mouse, then proceeds to step S3.

In step S3, the input system sets the cursor position detected from step S2 as the initial position, and forms an operating region on the monitor based on a user's setting to allow the user to input codes, and then proceeds to step S4.

In step S4, the user inputs the required code by moving the cursor within the operating region. It is noted that these codes correspond to the Chinese phonetic notations, but some of the codes may be different to the standard Chinese phonetic notations in that each code consists of a single continuous stroke while the corresponding standard Chinese phonetic notation may consist of multiple strokes. Thus, these codes are referred to as single-stroke codes. Since these single-stroke codes may be different from the well-known standard Chinese phonetic notations, user has to learn these codes beforehand in order for the input system to recognize them. The codes can be pre-defined by the supplier. The system traces the continuous track of the cursor within the operating region, and then proceeds to step S5.

In step S5, the input system determines the corresponding code from the continuous track (stroke) made by the cursor, and then determines the corresponding phonetic notation for the determined code.

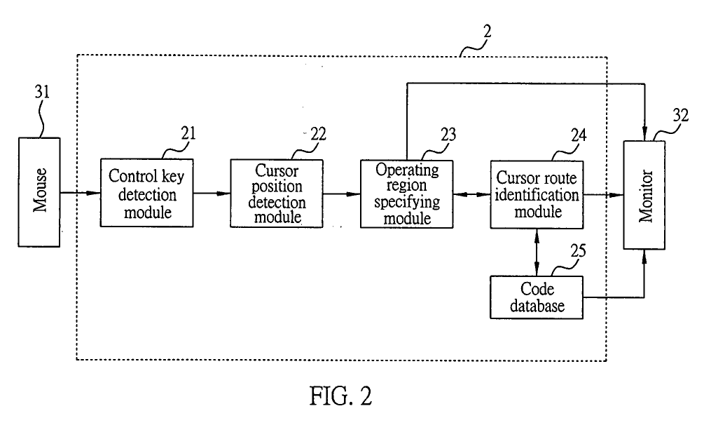

FIG. 2 is a block diagram showing system structure of the single-stroke code input system of the present invention. As illustrated, the single-stroke code input system 2 connects to a mouse 31 and a monitor 32, and it includes at least a control key detection module 21, a cursor position detection module 22, an operating region specifying module 23, a cursor route identification module 24 and a code database 25.

The control key detection module 21 is used to detect if the middle button of the mouse 31 is pressed down by the user, if yes, it means the user wishes to input codes, a start signal is sent, otherwise, original functionality of mouse 31 is retained till the middle button is pressed.

After the cursor position detection module 22 receives the start signal, it starts an input operation mechanism and detects the cursor position on the monitor 32 corresponding to the mouse 31.

The operating region specifying module 23 sets the detected cursor position as the initial position and specifies an operating region on the monitor in which the user can input codes.

The cursor route identification module 24 traces movement of the mouse 31 and identifies the code inputted by the user from the continuous route of the mouse 31.

The code database 25 finds a phonetic notation according to the code inputted by the user as identified above, so that the user can use the phonetic notations to form a complete character.

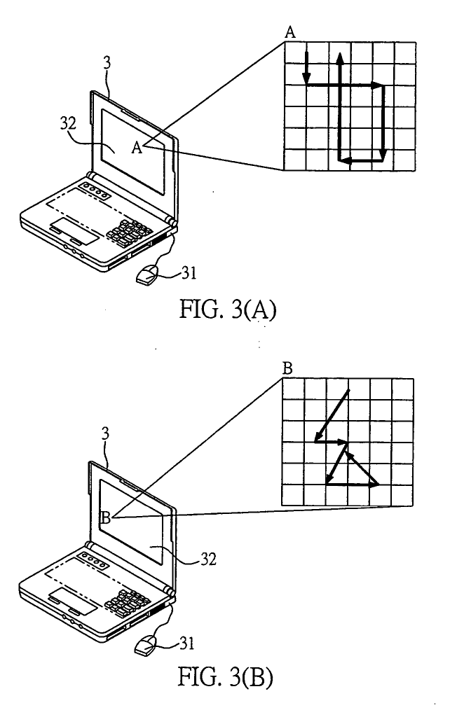

FIG. 3 (A) and 3 (B) are illustrations showing input operation of the present invention as applied to laptop computers. As illustrated, when the user wishes to input phonetic notations, the middle button of mouse 31 has be to clicked to start an input operation mechanism so that the system 2 of the present invention detects that point A on the monitor 32 is the current cursor position of the mouse 31. At the same time, the system 2 sets position of point A as an initial position (0,0) and extends rightwards and downwards to form an operating region of 36 cells (can be specified by the user), so that the user can move mouse 31 within the operating region to form a continuous route to input the required code. From the code database 25, based on the identified route, a phonetic notation corresponding to the code formed by the continuous stroke is found to be “ [symbol] ” and displayed on the monitor 32, then as illustrated in FIG. 3 (B), make the system 2 specify a new 36-cell operating region starting from initial position B, so that the user can move the mouse 31 to form another continuous stroke. Then another phonetic notation “ [symbol] ” is found via the code database based on the code represented by the stroke (route) and displayed on the monitor. In this case, the two phonetic notations can be combined to form a complete syllable “ [symbol] [symbol] ” and a list of Chinese characters candidates having this syllable is shown on the monitor 32 for the user to select, thus a character can be inputted.

While the present invention has been described in details with reference to the preferred embodiment above, it should not be construed as to limit the scope of the present invention. The technology disclosed in the present invention is broadly defined in the claim below. Any methods or embodiments presented by others that are identical or equivalent to the claims below are considered as within the scope of the claims.

What is claimed is:

1. A single-stroke code input method applicable to on electronic equipment with a monitor and an inputting device, for performing data input via a single-stroke code input system provided in the electronic equipment, the method comprising the following steps:
(1) activating an input operation mechanism by a user when the single-stroke code input system detects activation of a control key on the inputting device;
(2) having the system detect a cursor position on the monitor corresponding to the inputting device in order to specify an operating region for the user to input data; and
(3) having the single-stroke code input system output a notation that corresponds to a continuous route made by the cursor in the operating region.

2. The single-stroke code input method as claimed in claim 1, wherein the inputting device is one of a mouse and a touchpad.

3. The single-stroke code input method as claimed in claim 1, which can be used by the user to input at least one of the Chinese phonetic notations and the Arabic numerals.

4. The single-stroke code input method as claimed in claim 1, wherein the electronic equipment is one of a laptop computer and a desktop computer.

5. The single-stroke code input method as claimed in claim 1, wherein the step (1) further comprises that if the control key of the inputting device is not activated, original functionality of the inputting device is retained.

6. A single-stroke code input system applicable to an electronic equipment with a monitor and an inputting device, the system comprising:
a control key detection module for sending out a start signal when activation of a control key on the inputting device is detected;
a cursor position detection module for detecting a cursor position on the monitor corresponding to the inputting device after receiving the start signal;
an operating region specifying module specifying an operating region on the monitor for the user to input codes based on the detected cursor position;
a cursor route identification module for tracing a single continuous route made by the movement of the cursor within the operating region to identify a single-stroke code represented by the route; and
a code database for generating a notation according to the single-stroke code represented by the route and displaying it on the monitor.

7. The single-stroke code input system as claimed in claim 6, wherein the inputting device is one of a mouse and a touchpad.

8. The single-stroke code input system as claimed in claim 6, wherein the notation is any one selected from the group consisting of Chinese phonetic notations and Arabic numerals.

9. The single-stroke code input system as claimed in claim 6, wherein the operating region can be specified by the user.

10. The single-stroke code input system as claimed in claim 6, wherein the electronic equipment is one of a laptop computer and a desktop computer.
